(19) United States
(12) Patent Application Publication
(10) Pub. No.: US 2011/0106633 A1
(43) Pub. Date: May 5, 2011

(54) Method for Distributing Campaign Metadata Across Multiple Small Clients

(75) Inventor: Terry Cook, Bellevue, WA (US)

(73) Assignee: Zumobi, Inc., Seattle, WA (US)

(21) Appl. No.: 12/611,685

(22) Filed: Nov. 3, 2009

(51) Int. Cl. G06Q 30/00

(52) U.S. Cl. 705/14.73

(57) ABSTRACT

Various embodiments of the present invention are directed to a system and method which by calculating in advance what material is to be sent to a particular device and under what conditions that material is to be delivered, the material can be delivered ahead of time and used when the conditions are met. In one embodiment, a server is used to download to certain mobile devices (or to other devices having a limited bandwidth) a portion of an advertisement campaign together with the rules for displaying the various advertisements at the mobile device. The server can, if desired, keep track of the downloaded advertisements to all of the mobile devices so that the demographics of the advertising campaign are met within the desired time frame. The server can make use of the captured information, including demographics, to select ads for delivery to the mobile client that will be more likely to be acted upon by user, or more likely to meet future criteria and be shown.

### TECHNICAL FIELD

This disclosure relates to the provision of unsolicited data to a device over a high latency communication network and more particularly to systems and methods for delivering advertising material to a user's device in conjunction with the delivery of other data to the device.

### BACKGROUND

It has become common practice to deliver to a computer user non-solicited data, such as an advertising banner, in conjunction with data solicited by the user. By way of example, when using the Internet to retrieve a desired piece of information, the computer user often receives an advertisement pertaining to desired information. Thus, assuming the user has requested information on a particular make of automobile, a banner ad would appear at the same time that the desired information is received, the theory being that a user would be more receptive of an ad for a car dealer (or for some other aspect of automobiles) than he/she would be at some random time. The popularity of such banner or pop-up ads attests to their perceived effectiveness.

Problems exist, however, in situations such as occurs with wireless devices where bandwidth is limited in that delivering the advertisement at the proper time is troublesome at best and in many situations not practical. Latency in wireless is but one problem in that by the time the proper ad arrives the user is beyond the point where the ad is effective. Often the ad is delivered in conjunction with the wrong user request thus becoming annoying instead of being effective.

The reasons for such latency are many, but often it is a result of the fact that when the original data request by the user from a high latency device (cell phone, Blackberry, etc.) over a wireless connection, such as the cellular network, the system then must forward the request to a third party so that the third party can match the solicited information against a database of potential advertisements that “match” the solicited material. Then the non-solicited matched material (usually an advertisement in a similar category) must be transmitted to the device user. In high speed networks this latency can be reduced to millisecond range, making this an acceptable approach. However, when latency becomes a factor, (usually greater than 0.3 seconds) the unsolicited information arrives at the user's device at unpredictable and often inconvenient times.

### BRIEF SUMMARY

Various embodiments of the present invention are directed to a system and method which by calculating in advance what material is to be sent to a particular device and under what conditions that material is to be delivered, the material can be delivered ahead of time and used when the conditions are met. In one embodiment, a server is used to download to certain mobile devices (or to other devices having a limited bandwidth) a portion of an advertisement campaign together with the rules for displaying the various advertisements at the mobile device. The server can, if desired, keep track of the downloaded advertisements to all of the mobile devices so that the demographics of the advertising campaign are met within the desired time frame. The server can make use of the captured information, including demographics, to select ads for delivery to the mobile client that will be more likely to be acted upon by user, or more likely to meet future criteria and be shown.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 shows one embodiment of a system for delivering unsolicited data to a mobile phone; and

FIGS. 2 and 3 show embodiments in support of the concepts of the invention.

### DETAILED DESCRIPTION

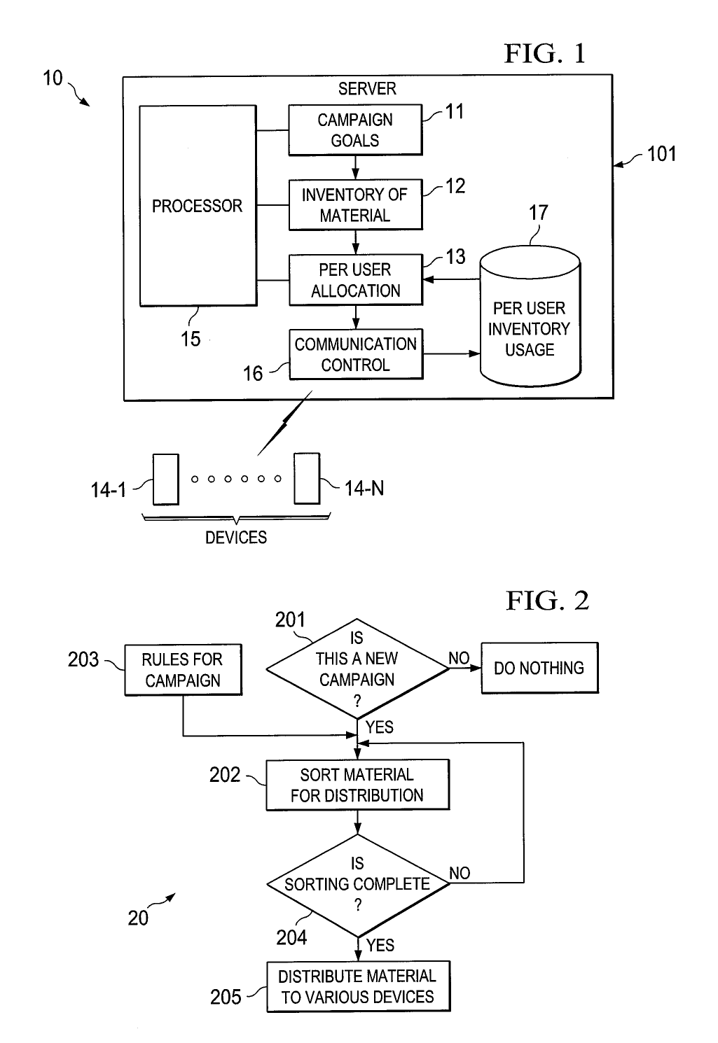

FIG. 1 shows one embodiment of a system, such as system 10, for delivering unsolicited data to mobile devices, such as cell phones 14-1 to 14-N. Processor 15 in this embodiment controls the operation of server 101. The server receives one or more campaigns with each campaign containing a multi number of items, such as advertisements, for distribution and one or more goal (rules). The campaigns are stored in memory 12 and the goals are stored in memory 11. Note that this storage arrangement is for ease of discussion and that any of a number of storage methods and arrangements can be used. The messages can be delivered to a device display screen (not shown) and/or to a device audio speaker (also not shown).

The campaign goals can be specific to a particular campaign or generic to a plurality of campaigns. One goal of a campaign, for example, is to establish when an item, such as a particular advertisement, is allowed to run. For example, the rule could be that a particular advertisement, or set of advertisements, can only run, for example, between the 1^{st} and the end of June. A global rule, usually established by contract for a period of time, could be that this items must be shown at least (or no more than) 20,000 times.

Processor 15, based upon demographic information gathered (or downloaded to it), divides the availably inventory into portions earmarked for particular users. The demographics can be generated by processor 15 based on prior usage of the devices or from data obtained from data gathering services external to server 101. One such external source can be, for example, surveys taken by survey firms, or from telephone or other records. The demographics could, for example, reflect a particular user's actual device operations, as determined from monitored usage. Such monitored usage could be via communication control 16 and user usage storage 17. Also, such demographics can be gathered based upon a user's reaction to a presentation of an advertisement (or other unsolicited data). Some of the information could come from information collected at user signup, user interaction with device, device characteristics, application performance characteristics, device state, or network performance characteristics. Included would be, for example, their age, their gender, their location, language, and probably some things about their interests.

The unsolicited data can be, for example, graphics, text, video, sound, streaming data, images, and data and could be presented to the user on the user's device, such as cell phone 14-1. Such a presentation can be a display on a screen and/or a voice message. Note that while the material that is presented to the user is being referred to herein as “unsolicited” material, the term unsolicited refers to the fact that the material is being presented to the user at time not controlled by the user directly but rather is being presented based upon an operation (request for data, or the usage of the device) initiated by the user, or by the passage of time. In fact, the material can be solicited by the user in that the user can sign up for certain material or certain types of material at a time not associated with a particular data request with the knowledge that the “unsolicited” material will not be presented until some other event occurs. An example of “pre-solicited” material would be specifications for certain types of items. Thus, if a user anticipates a project (remodeling a home, having a dinner party) the user would pre-solicit (register) such a project. Then the system, as will be described, will download for storage on the user's device relevant specifications, menus, tips, etc. to be presented to the user at times based upon other requests the user makes with respect to his/her communication device.

The division of data to a particular user is based, at least in part, on how many impressions are anticipated will be deliverable to a particular user in the time frame allocated. Different champagnes are in different champagne spaces (subject matters) and since the allocated material is a reflection of anticipated delivery possibilities, the allocations for a particular device will be different for each campaign. A certain set of the overall campaign material is allocated until it is all exhausted. This procedure is followed for any arbitrary number of clients, any arbitrary number of campaign goals, and any arbitrary number of impressions. The allocated number of information packets for any one user is small so that it can be stored on the device itself and downloaded via communication control 16 at a time convenient to the network and to the device (i.e., when the device is not otherwise busy). The downloading includes the rules for when a particular piece of information is to be presented to the user.

When the cell phone is in use and the user performs a certain function, for example, the user browses the Internet looking for an item, the device loaded rules then determines if the item is one that would trigger a particular unsolicited message. If so, then the message is presented (either visually or audibly) to the user. This actual usage is then collected and sent back to server 101 via communication control 16 for storage in user inventory usage memory 17. This then allows processor 15 to determine, from all of the feedback, if the campaign is running ahead or behind schedule and to adjust, if necessary, the downloaded data items, and perhaps even the rules so as to accomplish the mission.

The above description assumes all of the users use the applications equally. But, in actual practice, that isn't necessarily the case. Assume a goal of 20,000 impressions (presentations) are desired in the month of June. And assume that any one presentation is not to be shown it to any user more than ten times. Also, no user is to receive the same message less than five times. Thus, it is important to know how active each user is predicted to be so that the goals will be meet easily without a lot of rearranging. Once the campaign for a user is cached on a device, the system continues to evaluate the original allocation decision to be sure that the ads (or other material) are being presented to users at the predicted pace. Any reallocation can be hourly, daily, weekly, or any other period desired, and can serve to adjust the number of subsets and/or the frequency with which the subsets are delivered to the device.

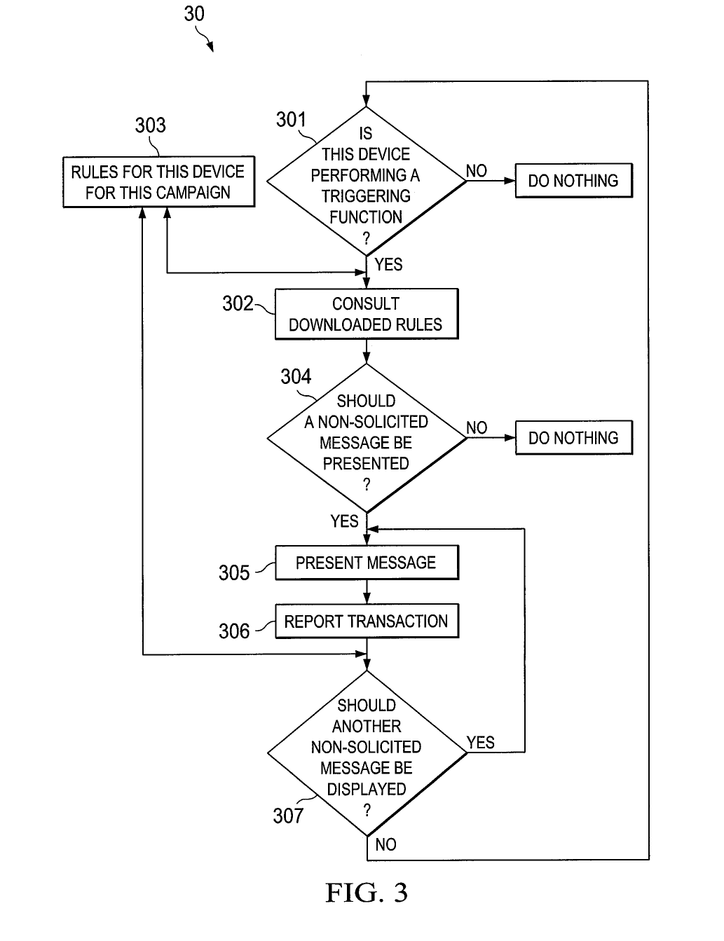

FIGS. 2 and 3 show embodiments in support of the concepts of the invention. These embodiments can run, if desired, on a PC or other system such as is shown in FIG. 1. In FIG. 2, process 201 of method 20 determines if a new campaign (or a redistribution of a previously distributed campaign) is available for distribution to user devices. If so, process 202 sorts the material for distribution. The material can be, for example, individual advertisements, or any other media (text, pictures, video, sound) desired. Process 202 works in conjunction with process 203 which provides the rules for the campaign. These rules can be specific to this one campaign (such as run dates, exposure times, exposures per device, age and/or gender of the device user, etc.) or the rules can be global, no downloads to anyone under a certain age, no material of a certain type to a certain user based on demographics, etc.).

Process 204 determines if sorting of the campaign material is complete. When it is, process 205 distributes the material to the various devices. This distribution will occur at a different time with respect to each device, depending upon the best time to distribute the material. All of the material for a particular device need not be downloaded at the same time depending upon bandwidth of the network and memory capacity of the device.

FIG. 3 shows method 30 in which process 301 determines if a particular device is in the process of performing a function that could trigger the presentation of “unsolicited” material previously stored on the device. If so, processes 302, 303 and 304 determine if a stored message should be presented. If a message is to be presented, process 303 determines the proper presentation mode and presents the material, either on a display screen, or via an audible (or vibratory) output. Process 306 then reports the transaction back to the server as discussed above.

Process 307 determines if another message or action needs to be taken and if so trigger the presentation of the additional message(s).

Note that while the concepts disclosed herein have been discussed in terms of advertising, any dynamics content can be cached in this manner and shown in response to rules evaluated at a future point in time.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of delivering non-solicited material over a low transmission band-width network for display to users of said networks on a user device in conjunction with information solicited over said network by said users, said method comprising:
receiving at each particular user device a set of said non-solicited material, said delivering being accomplished when jointly convenient to said network and said device, said non-solicited material being selected for each particular device in accordance with captured information of said user of said device; and
displaying at least one of said non-solicited material to said user at a particular one of said devices in accordance with rules for said displayed non-solicited material delivered with said material.

2. The method of claim 1 wherein said captured information comprises demographic information.

3. The method of claim 1 further comprising:
sending from time to time a record of what non-solicited material is displayed at each of said devices to a location remote from said devices.

4. The method of claim 3 further comprising:
re-receiving certain of said non-solicited material to said devices based upon receipt of said records.

5. The method of claim 4 wherein said rules coordinate said displaying of a particular one of said material with operations performed at said device.

6. The method of claim 5 wherein said operations comprise at least of the operations selected from the list of: soliciting of certain material from said device, performing a function at said device, displaying a message, displaying an image, displaying text content using a previously downloaded form.

7. The method of claim 4 wherein said non-solicited material delivered to a particular device is advertising material designed for displaying in conjunction with receipt at said particular device of certain material requested by said user of said device.

8. A server for delivery of material to a plurality of wireless devices, said server comprising:
a processor operable for determining for any given wireless device an appropriate subset of advertisements from an advertising campaign; and
wherein said processor is further operable for controlling transmission of a determined appropriate subset of advertisements from said server to a given wireless device, each said advertisement for display at said device in accordance with rules also transmitted to said device from said server.

9. The server of claim 8 wherein said rules are transmitted to said device together with said transmission of said advertisements.

10. The server of claim 8 wherein said processor is further operable for tracking for a plurality of said delivered subsets to a plurality of said devices actual display of each said advertisement at said devices.

11. The server of claim 8 wherein said processor is further operable for:
redefining said sub-sets of advertisements from time to time based on said tracking; and
for controlling retransmission of said redefined sub-sets to said plurality of said devices.

12. The server of claim 9 wherein said processor is further operable for determining said sub-set of advertising based on at least one of the following criteria:
demographics of users of each said device, statistics pertaining to past usage of said users of a device, device characteristics, previously viewed or downloaded content.

13. A system for distributing advertising to devices via a relatively slow network, said system comprising:
a server;
a memory at said server for storing demographic data pertaining to a plurality of devices accessible via said network;
a memory at said server for storing at least one advertising campaign, each said campaign containing a plurality of individual messages for display to users of said devices in conjunction with operations performed by said users; and
a processor for dividing each said campaign into subsets of said advertisements, each subset for delivery to an individual device together with rules for display of each said advertisement, said subset based, at least in part, on said stored demographics.

14. The system of claim 13 wherein said processor is operable for adjusting said delivered subsets from time to time during pendancy of a campaign in accordance with monitored actual display of said advertisements.

15. The system of claim 14 wherein said adjusting comprises at least one of:
adjusting size of delivered subset;
frequency of delivery.

16. The system of claim 15 wherein each said campaign contains rules for delivery of messages to said devices and wherein said initial subsets and any adjusted subsets are established based at least in part on said rules.

17. The system of claim 13 wherein said demographics are selected from the list of:
past usage of said device with respect to certain operations performed by user's of said device, past usage of said device with respect to information requested by user's of said device, anticipated usage of said device with respect to a set of targeted operations.

18. The system of claim 13 wherein said demographics are selected from information collected at user signup, user interaction with device, device characteristics, application performance characteristics, device state, network performance characteristics.

19. A system of delivering non-solicited material over a low transmission band-width network for display to users of said networks on a user device in conjunction with information solicited over said network by said users, said system comprising:
means for delivering to each particular user device a set of said non-solicited material, said delivering being accomplished when jointly convenient to said network and said device, said non-solicited material being selected for each particular device in accordance with demographics of said user of said device, said material for displaying to said user at a particular one of said devices in accordance with rules for said displayed non-solicited material delivered with said material.

20. The system of claim 19 further comprising:
means for receiving from time to time a record of what non-solicited material is displayed at each of said devices.

21. The system of claim 20 further comprising:
means for redelivering certain of said non-solicited material to said devices based upon receipt of said records.

22. The system of claim 19 wherein said rules coordinate said displaying of a particular one of said material with operations performed at said device.

23. The system of claim 22 wherein said non-solicited material delivered to a particular device is advertising material designed for displaying in conjunction with receipt at said particular device of certain material requested by said user of said device.

24. The system of claim 19 wherein said rules coordinate a media for displaying said material, said media selected from the list of text, video, audio, images, data, streaming data.

25. A computer program product having a computer readable medium having computer program logic recorded thereon for delivering non-solicited material over a low transmission band-width network for display to users of said networks on a user device in conjunction with information solicited over said network by said users, said computer program product comprising:
code for delivering to each particular user device a set of said non-solicited material, said delivering being accomplished when jointly convenient to said network and said device;
code for selecting said non-solicited material for each particular device in accordance with demographics of said user of said device, said material for displaying to said user at a particular one of said devices in accordance with rules for said displayed non-solicited material delivered with said material.

26. The computer program product of claim 25 further comprising:
code for receiving from time to time a record of what non-solicited material is displayed at each of said devices.

27. The computer program product of claim 26 further comprising:
code for redelivering certain of said non-solicited material to said devices based upon receipt of said records.
